(19) United States
(12) Patent Application Publication
(10) Pub. No.: US 2008/0214270 A1
(43) Pub. Date: Sep. 4, 2008

(54) Gaming Machine Capable Of Operating To Indicate The Number Of Bets, And Game Playing Method

(75) Inventor: Katsuhiro KIDO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 12/040,382

(22) Filed: Feb. 29, 2008

(30) Foreign Application Priority Data
Mar. 1, 2007 (JP) JP2007-051865

(51) Int. Cl. A63F 13/00

(52) U.S. Cl. 463/17

(57) ABSTRACT

Roulette is executed by placing a bet using a bet screen 70 displayed on a liquid crystal display 10. On the bet screen 70 is provided a bet-with-keno button 201 in addition to an ordinary bet button 75. When the amount of bets is indicated using the bet-with-keno button 201, a game (Keno) which is separate from Roulette is executed as a bonus game in parallel with Roulette, and the player is awarded a bonus payout based on an outcome of the bonus game.

### CROSS-REFERENCE TO RELATED APPLICATIONS

This application is based upon and claims a priority from the prior Japanese Patent Application No. 2007-051865 filed on Mar. 1, 2007, the entire contents of which are incorporated herein by reference.

### BACKGROUND OF THE INVENTION

1. Field of the Invention

This disclosure relates to a gaming machine capable of operating to indicate the number of bets, and a game playing method.

2. Description of Related Art

Conventionally, with games in which a side bet game is executed together with a main game, an operation of indicating the number of bets for the side bet game has been performed separately from an operation of indicating the original number of bets for the main game. Additionally, with the side bet game, it has been determined whether or not to award a bonus payout to a player thereof according to a game outcome in the main game. Furthermore, the determination to award the bonus payout to the player in the side bet game was based on a condition that a low-probability outcome is realized in the main game, since the bonus payout is relatively high (see, for example, U.S. Pat. No. 6,789,801B2, No. 5,711,525 and 6,874,786B2).

In the above manner, however, an opportunity for the player to be awarded the bonus payout in the side bet game is rare. Furthermore, in order to participate in the side bet game, it is necessary, as stated above, to take the trouble of indicating the number of bets for the side bet game, quite separately from indicating the original number of bets for the main game. Thus, there has been a trend that the player of the main game, who is discouraged by the above situation, will not willingly attempt to be awarded the bonus payout in the side bet game, and recedes from the side bet game.

### SUMMARY OF THE INVENTION

An object of the disclosure is to provide an unprecedented, novel gaming machine and game playing method by adjusting the main game and the bonus payout lottery through a one-time indication of the number of bets.

To achieve the object of the disclosure, there is provided a gaming machine, comprising: a display device for displaying a ball, a wheel including a plurality of pockets where a number is marked respectively and the ball is fallen, and a ticket marking each of the numbers marked on the pockets; an operation unit for allowing a player to indicate the number of bets of one of a first type and a second type for a plurality of bet spots; a memory for storing the number of credits held by the player; and a processor for executing roulette by using the ball and the wheel which are displayed on the display device when the number of bets of the first type is indicated by an operation on the operation unit, the processor, when the number of bets of the second type is indicated by an operation on the operation unit, programmed to execute the roulette and processes of: (a) selecting a predefined number of numbers out of the numbers which marked on the ticket displayed on the display device; (b) determining whether or not one of the selected numbers accords with the number which is marked on the pocket into where the ball is fallen by executing of the roulette after the selection and after displaying, on the display device, a state of that the ball is fallen into the pocket by executing of the roulette; and (c) adding the number of credits according to the total numbers of the determined numbers of the accordance, at a point in time when the determination repeated a predefined number of times, as a side bet bonus, to the number of credits in the memory and storing the sum.

Furthermore, according to another aspect, there is provided a game playing method which executes a roulette by using a ball and a wheel including a plurality of pockets where a number is marked respectively and the ball is fallen when a player indicates the number of bets of a first type, comprising, so as to make a game proceed in parallel with the roulette, the steps of: when the player indicates the number of bets of a second type, (a) selecting a predefined number of numbers out of the numbers marked on a ticket marking each of the numbers marked on the pockets; (b) determining whether or not one of the selected numbers accords with the number which is marked on the pocket into where the ball is fallen by executing of the roulette after the selection and after the ball's falling into the pocket by executing of the roulette; and (c) awarding, to the player, as a side bet bonus, the number of credits according to the total numbers of the determined numbers of the accordance at a point in time when the determination repeated a predefined number of times.

### BRIEF DESCRIPTION OF THE DRAWINGS

FIG. 1 is an explanatory view showing a bet screen displayed on a liquid crystal display of a terminal according to a present embodiment;

FIG. 2 is an outline view of a roulette gaming machine according to the present embodiment;

FIG. 3 is an outline view of the terminal according to the present embodiment;

FIG. 4 is a block diagram schematically showing a control system of the roulette gaming machine according to the present embodiment;

FIG. 5 is a block diagram schematically showing a control system of the terminal according to the present embodiment;

FIG. 6 is an explanatory view showing a betting board or the like displayed on a bet screen on the liquid crystal display of the terminal according to the present embodiment;

FIG. 7 is an explanatory view showing a wheel or the like displayed on the bet screen on the liquid crystal display of the terminal according to the present embodiment;

FIG. 8 is an explanatory view showing the bet screen displayed on the liquid crystal display of the terminal according to the present embodiment;

FIG. 9 is an explanatory view showing the betting board displayed on the bet screen on the liquid crystal display of the terminal according to the present embodiment;

FIG. 10 is an explanatory view showing the betting board displayed on the bet screen on the liquid crystal display of the terminal according to the present embodiment;

FIG. 11 is an explanatory view showing the bet screen displayed on the liquid crystal display of the terminal according to the present embodiment;

FIG. 12 is an explanatory view showing the betting board displayed on the bet screen on the liquid crystal display of the terminal according to the present embodiment;

FIG. 13 is an explanatory view showing the bet screen displayed on the liquid crystal display of the terminal according to the present embodiment;

FIG. 14 is an explanatory view showing a main screen displayed on a front display according to the present embodiment;

FIG. 15 is a flow chart of a game processing program in the roulette gaming machine according to the present embodiment;

FIG. 16 is a flow chart of a game processing program in the roulette gaming machine according to the present embodiment;

FIG. 17 is an explanatory view showing the wheel or the like displayed on the bet screen on the liquid crystal display of the terminal according to the present embodiment;

FIG. 18 is a schematic view of an exemplary application of the present invention to a table game.

### DETAILED DESCRIPTION OF THE PREFERRED EMBODIMENTS

In the following, a multi-player roulette gaming machine according to the present invention will be described in detail referring to the drawings based on an embodiment implemented on a roulette gaming machine. Here, the roulette gaming machine according to the present embodiment is one type of multi-player gaming machines comprising a plurality of terminals for accepting inputs from the players and executes European roulette, which is a kind of roulette games.

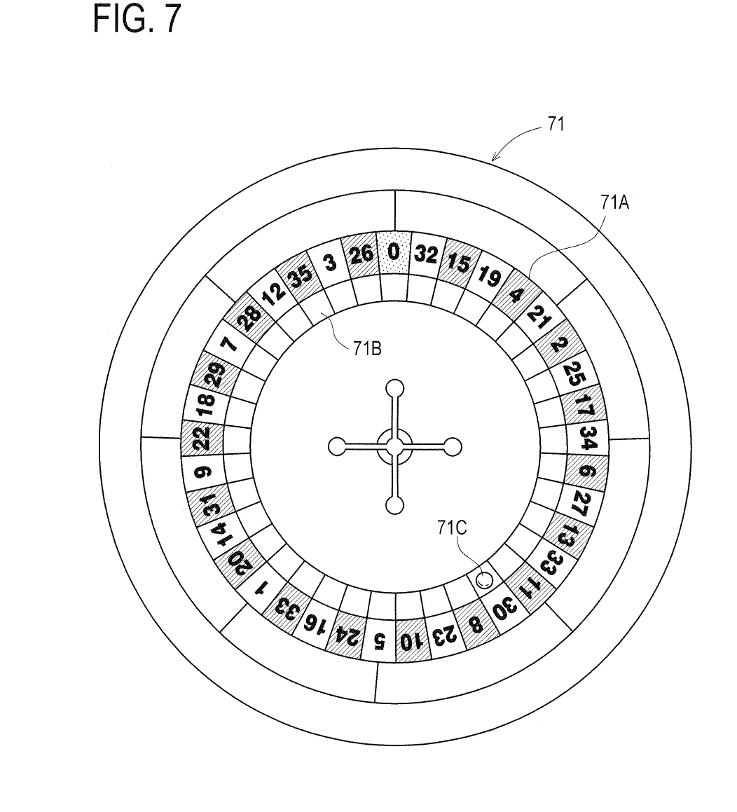

Here, for example, European roulette (abbreviated to simply “Roulette” hereafter) is a game with the wheel 71A of the type that there is not a pocket 71B marked “00”, as shown FIG. 7. In Roulette, each player first expects the pocket 71B into which the ball 71C is fallen and bets a certain amount of chips on the pocket 71B into which the ball 71C is fallen. Then the ball 71C is thrown by a dealer onto the spun wheel 71A, the pocket 71B which the player bets are compared with the pocket 71B into which the ball 71C is fallen actually on the spun wheel 71A to determine the win or loss. If the player's bet target is a number or a color relating to the pocket 71B into which the ball 71C is fallen actually, it is determined that the player has won the game, and a payout is made according to the amount of bets.

Here, a plurality of types of method indicating the bet target, in other words, types of method placing the chips are well known, their explanation is omitted here. The roulette gaming machine according to the present invention may execute only European roulette but also American roulette or Mexican roulette.

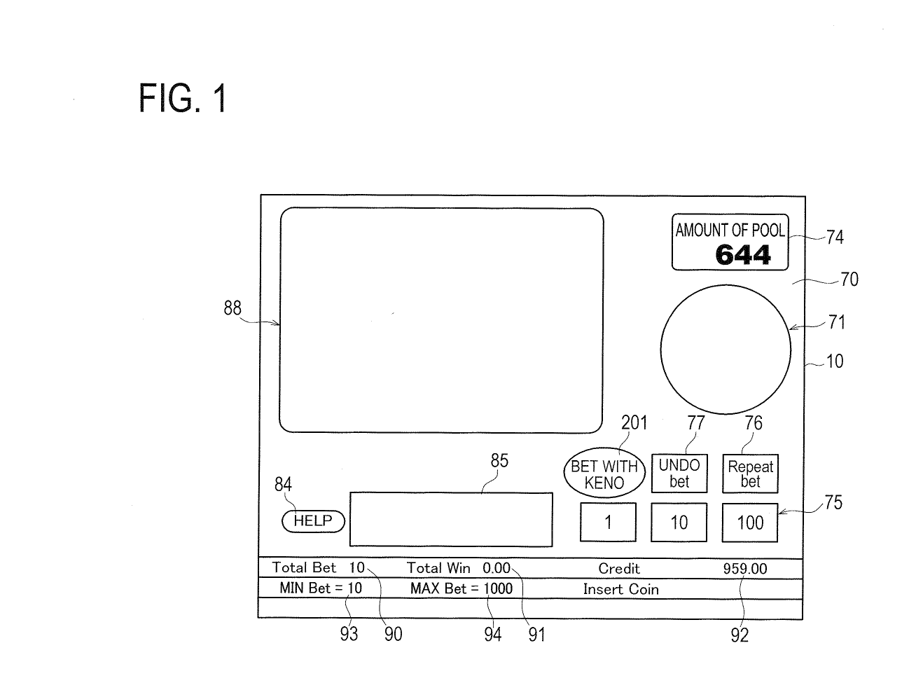

The roulette gaming machine according to the present invention has, in addition to an ordinary bet button 75, a bet-with-keno button 201, such as a bet screen particularly shown in FIG. 1. When the amount of bets is indicated by both the bet-with-keno button 201 and the bet button 75, a game which is separate from Roulette is executed as a bonus game in parallel with Roulette, and a bonus payout is awarded to the player based on an outcome of the bonus game.

Keno is executed as the bonus game. On a ticket to be used in Keno as the bonus game, there are only 36 numbers from “0” to “36”. However, on a ticket to be used in normal Keno, there are 80 numbers. Therefore, the difference with Keno as the bonus game and normal Keno is the numbers on each of the tickets. In other words, each of the numbers on the ticket to be used in Keno as the bonus game accords with each of the numbers that are marked on the pockets 71B of the wheel 71A to be used in Roulette. In Keno as the bonus game, it is determined whether or not each of the numbers on the ticket accords with a number that is marked on the pocket 71B into which the ball 71C is fallen actually. In this manner, Keno relating to Roulette is executed as the bonus game.

In the following, for simplicity of description, the phrase “when the amount of bets is indicated by both the bet-with-keno button 201 and the bet button 75” may be occasionally expressed, for example, “when the amount of bets is indicated using the bet-with-keno button 201”.

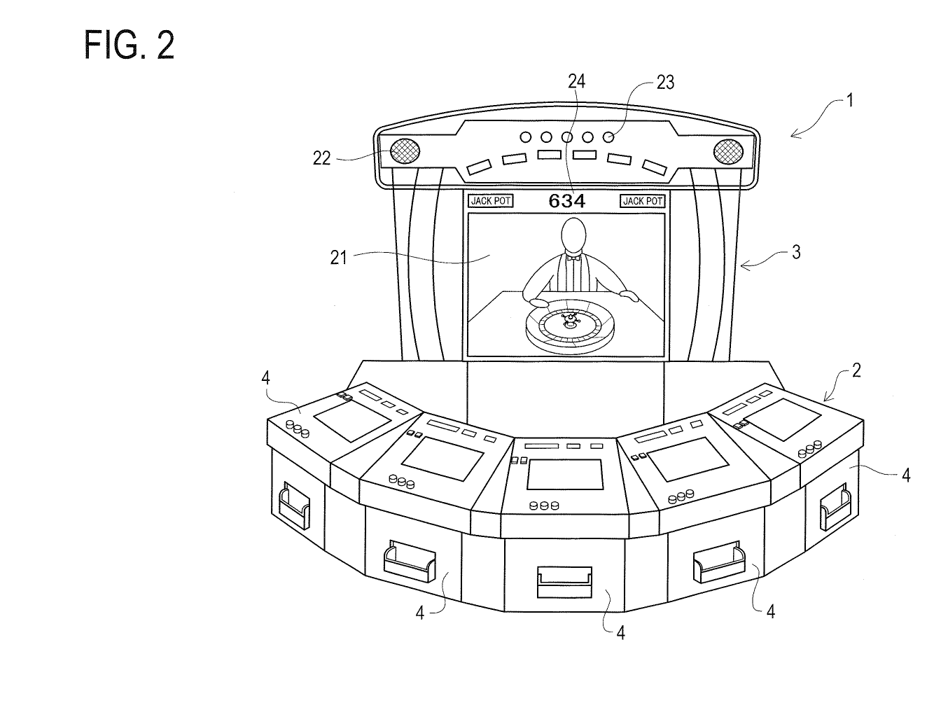

First, a structural overview of the roulette gaming machine 1 according to the present embodiment will be described, referring to FIG. 2. FIG. 2 is an outline view of the roulette gaming machine 1 according to the present embodiment.

The roulette gaming machine 1 according to the present embodiment generally comprises a table unit 2 at which the player sits and plays the game, and a panel unit 3 provided behind the table unit 2 to display animation images of the dealer.

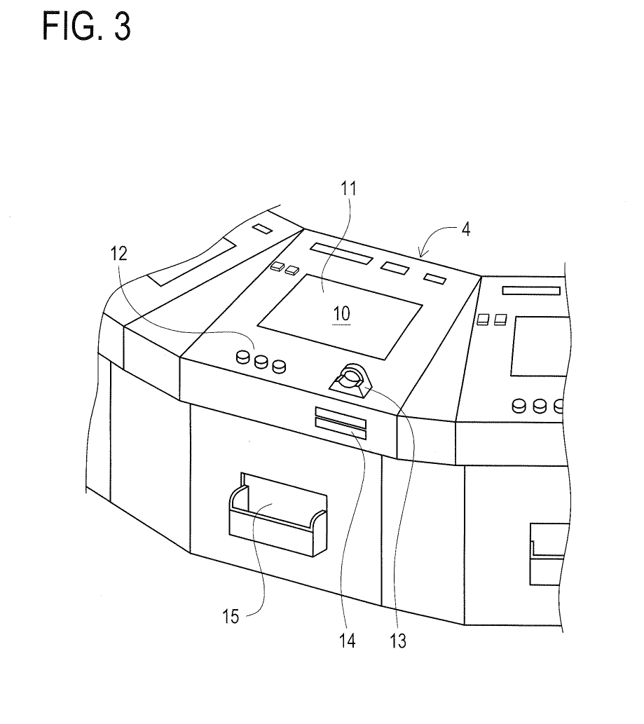

First, the table unit 2 will be described below. The table unit 2 has a plurality (five in FIG. 2) of terminals 4 referred to as satellites arranged in generally a fan-like manner. Here, FIG. 3 is an outline view of a terminal 4 according to the present embodiment.

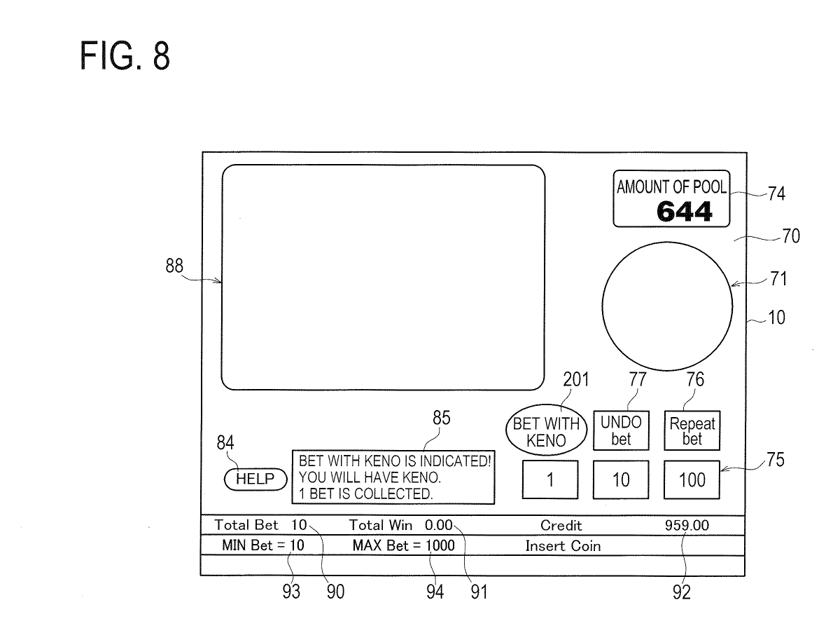

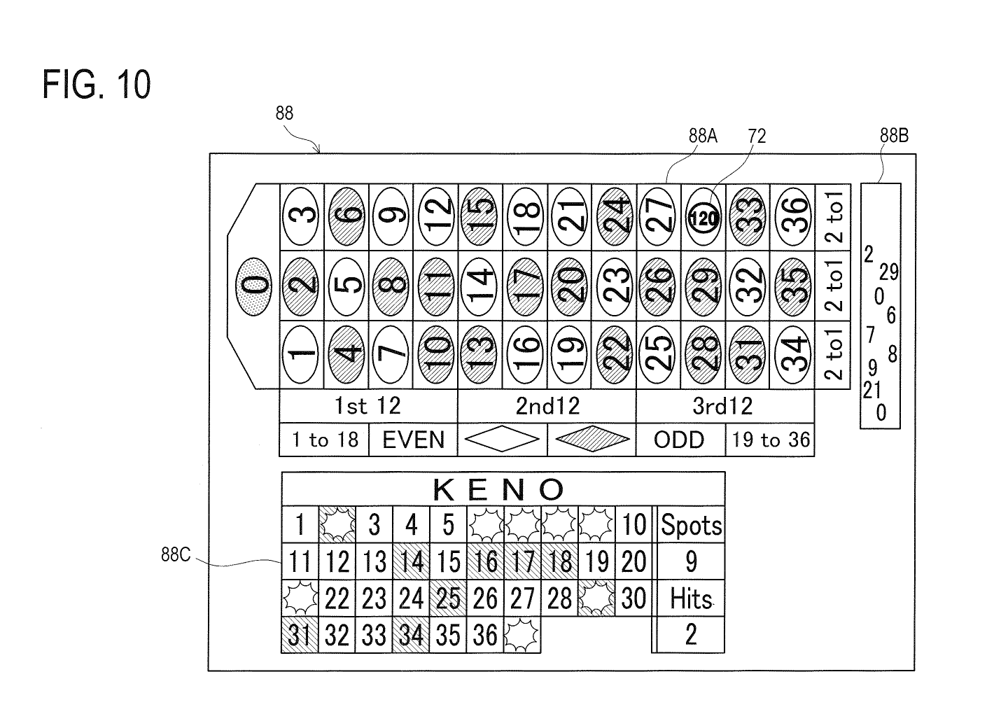

As shown in FIG. 3, the terminal 4 comprises a liquid crystal display 10 for displaying the bet screen (see FIGS. 8 and 10) described below and the game outcome or the like, a touch panel 11 provided on the front face of the liquid crystal display 10 and used for selecting the buttons which are displayed on the liquid crystal display 10 when selecting the bet target and indicating the amount of bets, an operation button 12 for performing a payout operation, a coin insertion slot 13 for inserting coins or medals, a bill insertion slot 14 for inserting bills, and a coin payout opening 15 for paying out, to the player, coins or medals corresponding to the accumulated credits when a payout operation is performed.

Referring to FIG. 2 again, the panel unit 3 comprises a front display 21, speakers 22 provided on the upper part of the front display 21 for outputting music or sound effects along the progress of the game, and LEDs 23 which light up when a variety of effects are performed. With regard to this, the front display 21 displays images of the dealer who is spinning the wheel 71A in one direction and spinning the ball 71C in the opposite direction or delivering the chips. Furthermore, the front display 21 displays images of the ball 71C which eventually is falling onto the wheel 71A and into the pocket 71B or the like.

Furthermore, an amount of pool display area 24 is provided on the upper part of the front display 21. In the roulette gaming machine 1 according to the present embodiment, as stated below, the number of credits according to an amount of bets (here, 1 bet) is separately collected from the player who is playing Keno, is pooled in a pot, if no payout is awarded to the player in Keno as the bonus game. Then, in Keno which is executed in case of indicating the amount of bets by the player by both the bet-with-keno button 201 and the bet button 75, the total amount of pool is awarded to the player if there is a bonus payout. Here, the amount of pool display area 24 displays the amount of credits currently pooled.

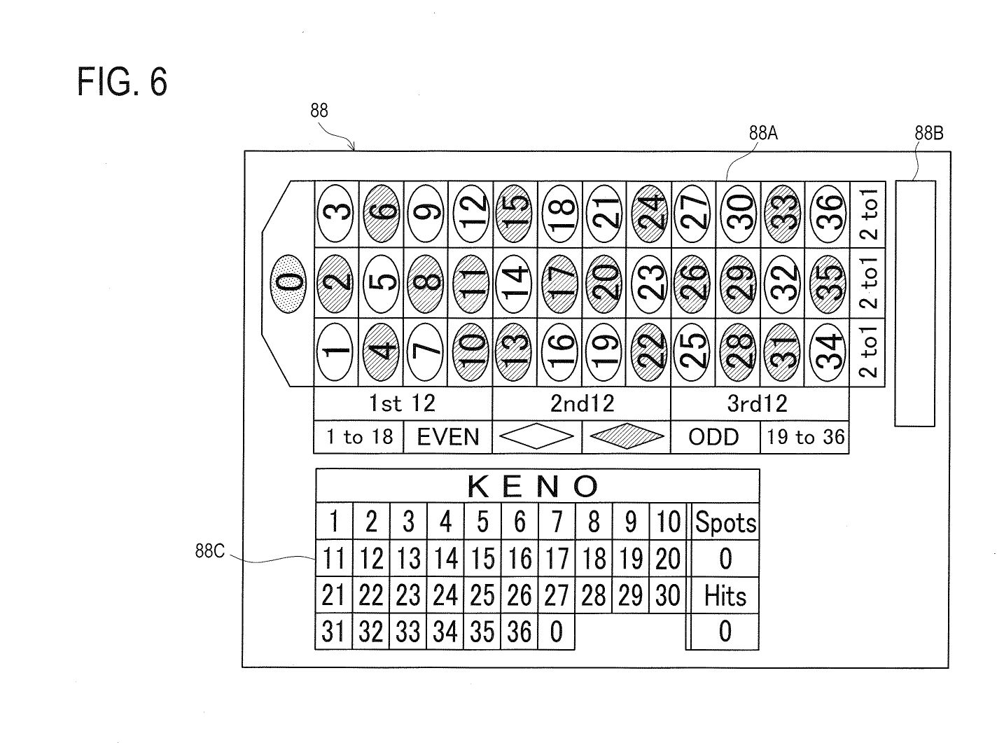

Here, as stated above, because the roulette gaming machine 1 according to the present embodiment executes European roulette, there is no pocket marked “00” on the wheel 71A and a betting board 88A (see FIG. 6) used in the roulette gaming machine 1 according to the present embodiment.

Next, a playing method of Roulette in the roulette gaming machine 1 arranged as above will be described, wherein the player who is going to play the game sits in front of the terminal 4 and places a desired amount of bets using the bet screen displayed on the liquid crystal display 10. On the other hand, the images of the ball 71C, which is thrown by the dealer onto the spun wheel 71A and eventually falling into one of the pockets 71B, are displayed on the front display 21 and each of the liquid crystal displays 10. Furthermore, if the player wins for the bet, credits multiplied the odds of the player's bet target by the amount of bets (number of credits) which has been placed is provided as an award at each of the terminals 4. On the other hand, no award is provided if the player loses for the bet. Additionally, when the amount of bets is indicated by both the bet-with-keno button 201 and the bet button 75 in particular, a game (Keno) separate from Roulette is executed as the bonus game in parallel with Roulette, regardless of the player's winning, or losing in Roulette, and a bonus payout is awarded to the player based on the outcome of the bonus game (Keno).

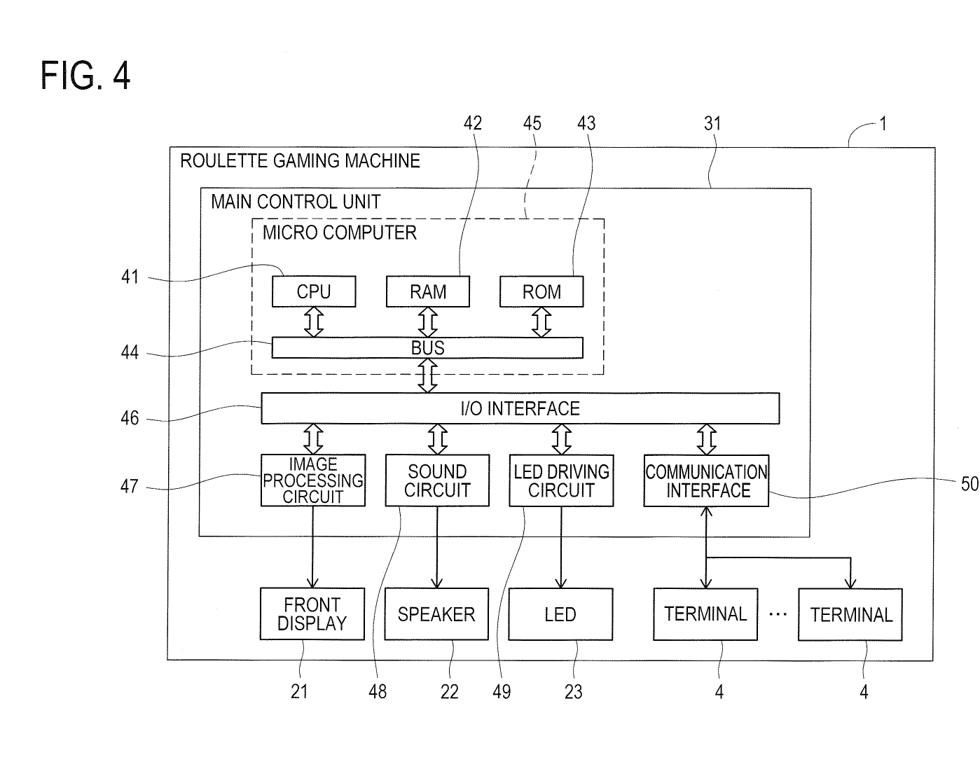

Next, the arrangement related to a control system of the roulette gaming machine 1 will be described, referring to FIG. 4. FIG. 4 is a block diagram schematically showing the control system of the roulette gaming machine 1 according to the present embodiment.

The roulette gaming machine 1 according to the present embodiment comprises, as shown in FIG. 4, a main control unit 31, a plurality of terminals 4 connected to the main control unit 31, and a variety of peripheral devices.

The main control unit 31 is generally composed of a micro-computer 45 as the kernel comprising a CPU 41, a RAM 42, a ROM 43 and a bus 44 for transferring data mutually between these elements. The ROM 43 stores a variety of programs, data tables or the like for executing necessary processes to control the roulette gaming machine 1. The RAM 42 is a memory for temporarily storing a variety of data (such as variables N and M described below) which have been operated in the CPU 41. Furthermore, the RAM 42 is a memory for storing the amount of pool which is pooled in the pot. The ROM 43 also stores image data of the wheel 71A, the betting board 88A, and the ball 71C or the like. Particularly, with the roulette gaming machine 1 according to the present embodiment, a game (Keno) which is separate from Roulette may be executed as the bonus game in parallel with Roulette as stated above, in which case the image data of the ticket used in the bonus game (Keno) is also stored (see FIG. 6).

In addition, the CPU 41 is connected, via an I/O interface 46, to an image processing circuit 47, a sound circuit 48, an LED driving circuit 49, and a communication interface 50.

The main control unit 31 receives player's bet operation information related to the amount of bets from each of the terminals 4 and determines whether or not a condition is realized to start Roulette. Then, upon starting Roulette, the main control unit 31 assigns, based on a lottery result, one of numbers which are respectively marked on the pockets 71B of the wheel 71A to the result of the lottery (on the display screen, the ball 71C on the spun wheel 71A is falling into the pocket 71B which is marked the assigned number). As the result, the win or loss (either the player has won or lost) is determined based on the pocket 71B into which the ball 71C is fallen, and the main control unit 31 transmits the result of determination to each of the terminals 4. Subsequently, each of the terminals 4 increases or decreases the accumulated credits according to the result of win or loss received from the main control unit 31.

Furthermore, the main control unit 31 identifies the terminal 4 at which the player's bet operation has been performed on both the bet-with-keno button 201 and the bet button 75 according to the bet operation information received from each of the terminals 4. For the identified terminal 4, the main control unit 31 executes Keno relating to each of numbers that are marked on the pockets 71B into which the ball 71C will be fallen in a predetermined number of times of Roulette repeated after the player's bet operation. The main control unit 31 transmits a result of Keno to the terminal 4. Subsequently, based on the result of Keno from the main control unit 31, the terminal 4 increases the accumulated credits by an amount of the bonus payout.

In addition, the main control unit 31 also outputs image signals to be displayed on the front display 21, and controls driving of the speakers 22 and the LEDs 23.

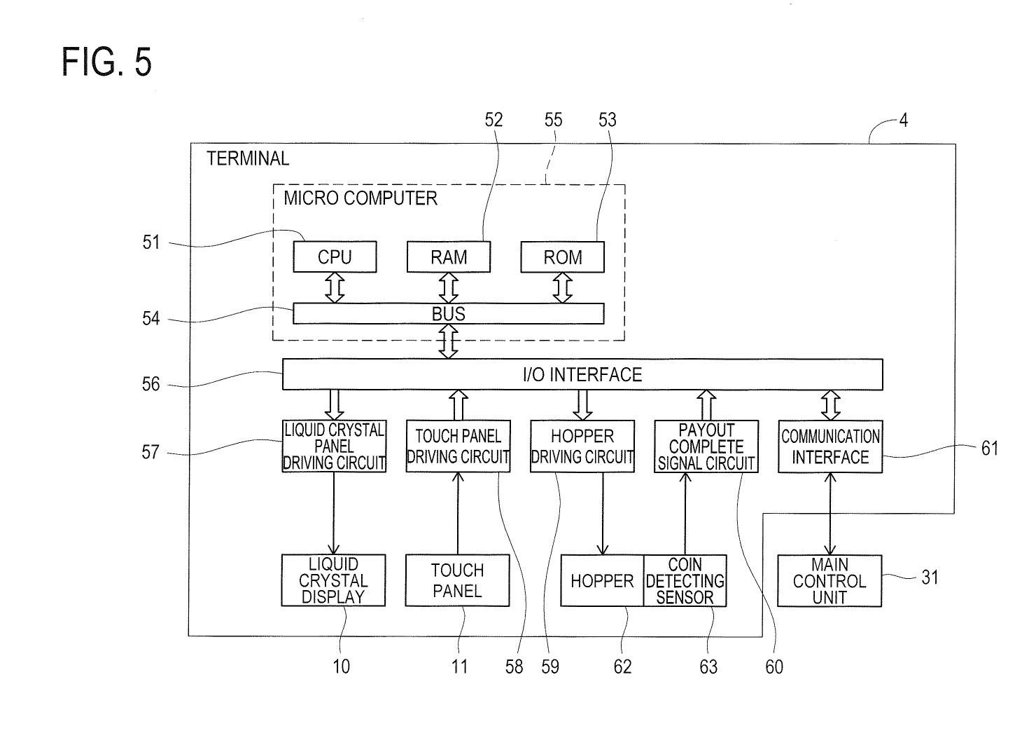

Next, the arrangement related to a control system of the terminal 4 will be described, referring to FIG. 5. FIG. 5 is a block diagram schematically showing the control system of the terminal 4 according to the present embodiment.

The terminal 4 according to the present embodiment is generally composed of a microcomputer 55 as the kernel comprising a CPU 51, a RAM 52, a ROM 53 and a bus 54 for transferring data mutually between these elements, as shown in FIG. 5. ROM 43 includes a variety of programs, data tables or the like stored therein for executing necessary processes to control the terminal 4. The RAM 52 is a memory for temporarily storing a variety of data which have been operated in the CPU 51, such as the number of credits (that is, the number of credits held by the player at the terminal 4) currently accumulated on the terminal 4, the bet target on which the player placed a bet, the bet type (whether or not the bet-with-keno button 201 has been used), the amount of bets (number of credits) which has been placed on the bet target or the like.

In addition, the CPU 51 is connected, via an I/O interface 56, to a liquid crystal panel driving circuit 57, a touch panel driving circuit 58, a hopper driving circuit 59, a payout complete signal circuit 60, and a communication interface 61. Furthermore, a liquid crystal display 10 is connected to the liquid crystal panel driving circuit 57, a touch panel 11 is connected to the touch panel driving circuit 58, a hopper 62 is connected to the hopper driving circuit 59, and a coin detecting sensor 63 is connected to the payout complete signal circuit 60, respectively. Additionally, the main control unit 31 is connected to the communication interface 61.

Based on operation information which is output from the touch panel 11, the CPU 51 calculates the amount of bets (number of credits) placed by the player and identifies the player's bet target, then, together with information about whether or not the bet operation has been performed using the bet-with-keno button 201 (type of bet), stores them into the RAM 52 and transmits them to the main control unit 31. Furthermore, the CPU 51 increases or decreases the accumulated credits according to the win or loss transmitted from the main control unit 31. Additionally, when the player has performed the bet operation using the bet-with-keno button 201, the CPU 51 increases the accumulated credits according to the result of Keno transmitted from the main control unit 31.

In addition, the CPU 51 also outputs image signals to be displayed on the liquid crystal display 10, and controls payout of coins from the coin payout opening 15 by the hopper 62 and the coin detecting sensor 63.

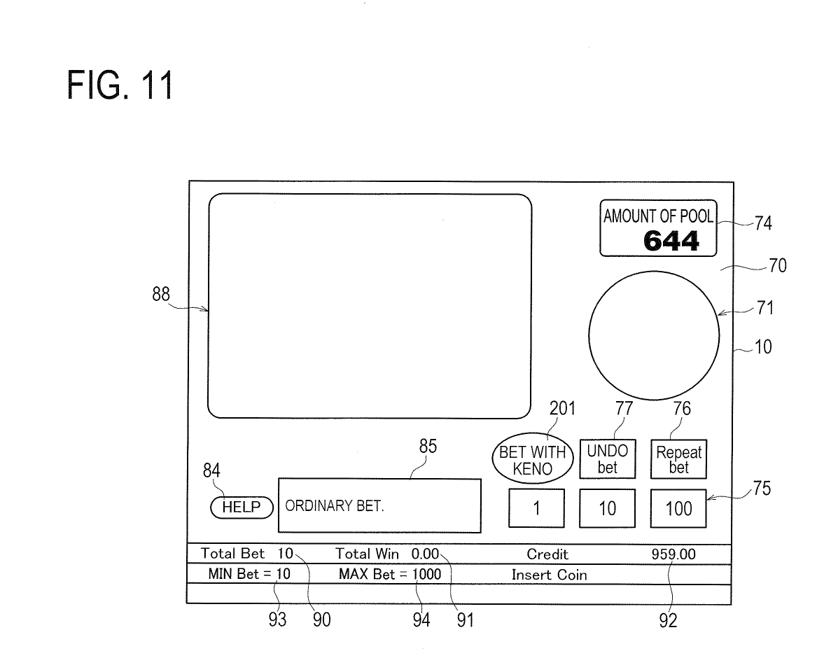

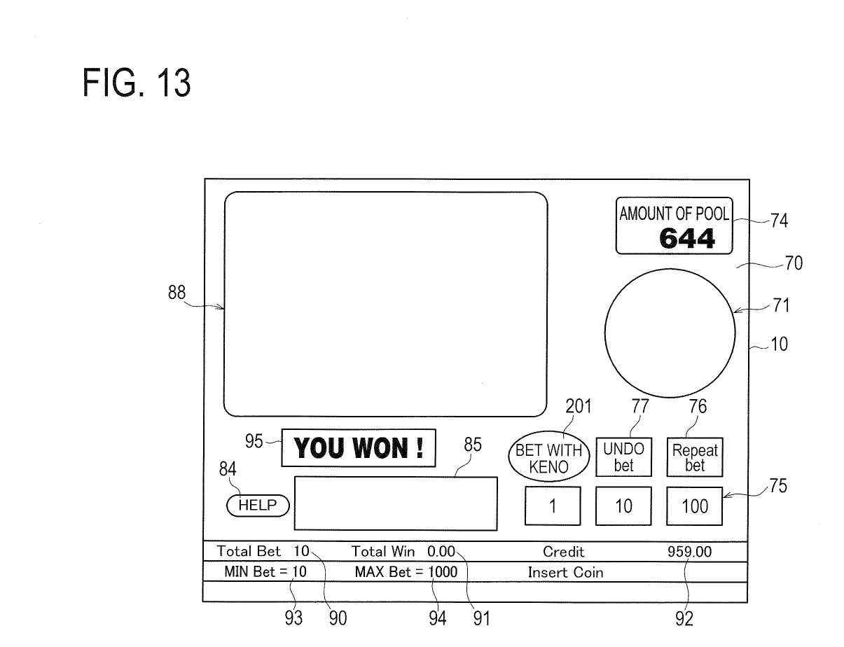

Next, a bet screen 70 which is displayed on the liquid crystal display 10 of the terminal 4 when Roulette is played on the roulette gaming machine 1 according to the present embodiment will be described, referring to FIG. 1, FIG. 8, FIG. 11 and FIG. 13. FIG. 1, FIG. 8, FIG. 11 and FIG. 13 are diagrams showing the bet screen 70 displayed on the liquid crystal display 10 of the terminal 4. Here, with the roulette gaming machine 1 according to the present embodiment, the player uses the bet screen 70 and the touch panel 11 to perform a bet operation of placing a certain amount of credits. With regard to this, the bet operation includes an ordinary bet operation which is performed only on the bet button 75 without using the bet-with-keno button 201, and a bet-with-keno operation which is performed on both the bet-with-keno button 201 and the bet button 75.

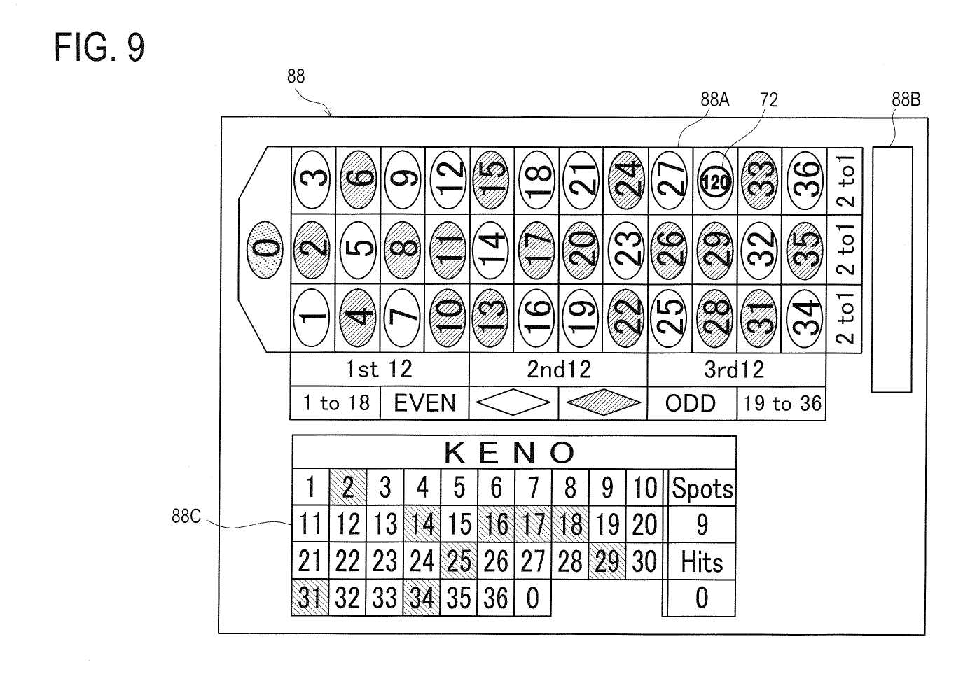

As shown in FIG. 1, FIG. 8, FIG. 11 and FIG. 13, the bet screen 70 comprises a wheel display area 71 for displaying the wheel 71A onto which the thrown ball 71C is fallen into one of the pockets 71B, a chip display area 88 for displaying a image 72 (see FIGS. 9, 10, and 12) of the chips which have been bet, an amount of pool display area 74 for displaying the amount of pool which is pooled in the pot, and an information display area for displaying a variety of operation buttons and information of the player. With regard to this, the chip display area 88 displays the betting board 88A, a result history of roulette 88B, and a ticket of keno 88C (see FIG. 6).

Here, the wheel display area 71 displayed a series of images. In the series of images, the wheel 71A is spinning, the ball 71C is thrown, the ball 71C is falling into one of the pockets 71B, and the wheel 71A is stopping.

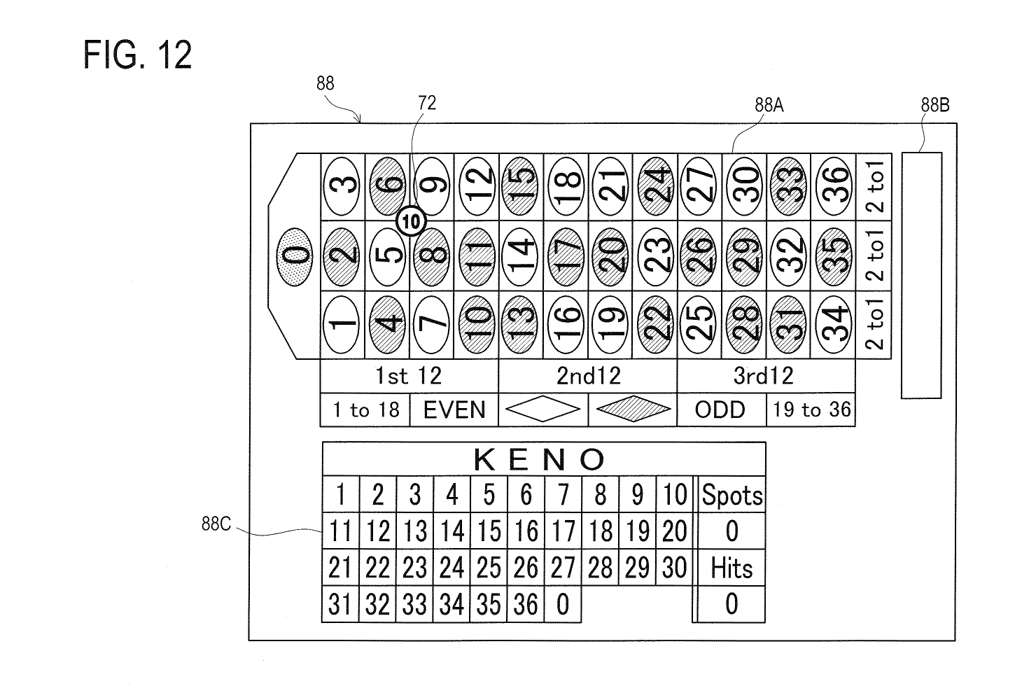

Here, the chip display area 88 displays the betting board 88A, the result history of roulette 88B, and the ticket of keno 88C shown in FIG. 6, FIG. 9, FIG. 10 and FIG. 12. The betting board 88A is displayed a plurality of bet squares relating to the numbers or the colors that are marked on or colored to the pockets 71B on the wheel 71A. The player then determines the player's bet target in Roulette by touching any of the bet squares in the betting board 88A. The terminal 4 transmits the determined player's bet target in Roulette to the main control unit 31. The result history of roulette 88B displays 16 numbers that are marked on the pockets 71B into which the ball 71C were fallen in 16 past games until the last time. The ticket of keno 88C displays a plurality of bet squares relating to each of the numbers that are marked on the pockets 71B of the wheel 71A. Then, the player determines the player's bet target in Keno by touching any of the bet squares on the ticket of keno 88C. The terminal 4 transmits the determined player's bet target in Keno to the main control unit 31.

In the chip display area 88, the betting board 88A displays the image 72 of chips corresponding to the amount of bets placed by the player (for example, chips corresponding to 120 credits are bet in FIG. 9 and FIG. 10 and chips corresponding to 10 credits are bet in FIG. 12). The player then selects the amount of bets using the bet button 75, determines the amount of bets by touching the chip display area 88. The terminal 4 transmits the determined amount of bets to the main control unit 31.

In addition, a plurality of the bet buttons 75 (three in the present embodiment, i.e., “one credit”, “10 credits”, and “100 credits”) are provided on the lower right hand side of the chip display area 88. Then, the player can select the amount of bets to be placed in the current game by touching the bet button 75.

Additionally, the bet-with-keno button 201 is provided above the bet button 75. The player can indicate the amount of bets using the bet button 75 as a bet-with-keno operation by touching the bet-with-a-bonus button 201 once.

However, if the amount of bets is indicated by using only the bet button 75 without touching the bet-with-keno button 201, the operation turns out to be an ordinary bet operation.

Furthermore, a Repeat bet button 76 and an UNDO bet button 77 are provided above the bet button 75. The player can place a bet which is the same amount of bets as the previous game by touching the Repeat bet button 76. In addition, a bet operation performed once can be canceled by touching the UNDO bet button 77. Furthermore, a bet-with-keno operation can be canceled by touching the UNDO bet button 77.

In addition, a HELP button 84 is provided on the lower side of the chip display area 88. The HELP button 84 is a button to be touched when displaying operation instructions of the roulette gaming machine 1 on the liquid crystal display 10. Additionally, a message area 85 for displaying messages that support the progress of game is provided on the right hand side of the HELP button 84.

On the message area 85, messages such as “BET WITH KENO IS INDICATED! YOU WILL HAVE KENO. 1BET IS COLLECTED.” are displayed, as shown in FIG. 8 while a bet-with-keno operation is being performed. While, on the other hand, an ordinary bet operation is being performed, a message such as “ORDINARY BET.” is displayed, as shown in FIG. 11.

At the lower part of the bet screen 70, a bet amount display area 90 for displaying the amount of bets currently placed by the player, an acquisition amount display area 91 for displaying the amount provided to the player as an award in the game, a held credit display area 92 for displaying the number of credits currently held by the player, a lower-limit-of-bet-amount display area 93 displaying the lower limit of the amount of bets that can be placed by the player, and an upper-limit-of-bet-amount display area 94 displaying the upper limit of the amount of bets that can be placed by the player.

Additionally, as shown in FIG. 13, a win-or-loss display area 95 displaying whether or not the player wins for the bet is provided on the lower side of the chip display area 88. Here, if the player wins for the bet, a character string “YOU WON!” is displayed on the win-or-loss display area 95. Furthermore, a character string “YOU LOST!” is displayed on the win-or-loss display area 95 when the player loses for the bet.

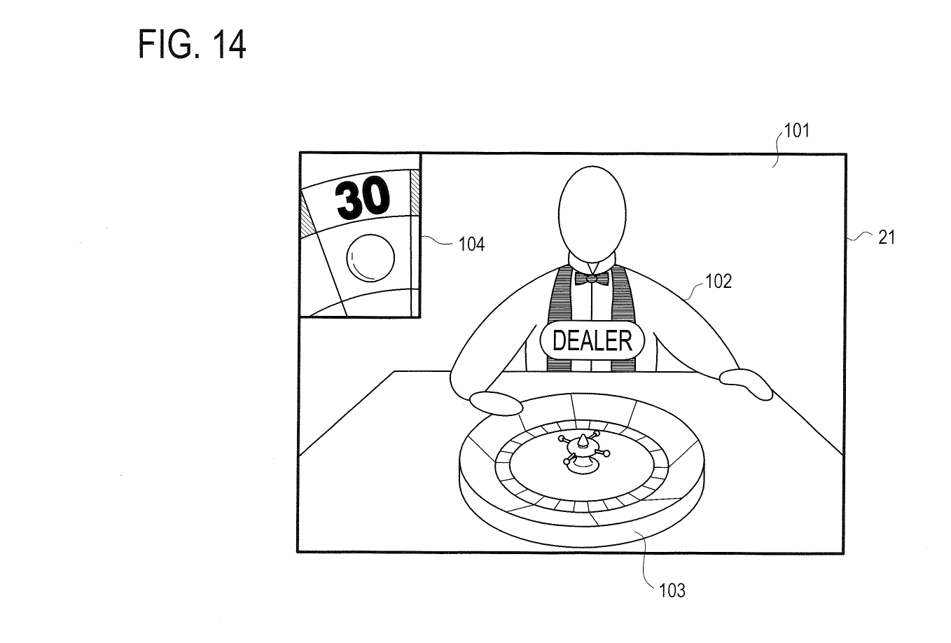

Next, a main screen 101 displayed on the front display 21 will be described referring to FIG. 14, when playing Roulette in the roulette gaming machine 1 according to the present embodiment.

FIG. 14 is a diagram showing the main screen 101 displayed on the front display 21. Here, with the roulette gaming machine 1 according to the present embodiment, images 102,103 of the dealer animated to perform spinning of a wheel along the progress of the game or the like is displayed on the main screen 101 in order to improve the sense of reality of the game.

An enlarged image 104 of the pocket 71B, into which the ball 71C are fallen, is displayed on the upper left part of the main screen 101.

Next, based on the bet screen 70 which is displayed on the liquid crystal display 10 of the terminal 4 when Keno is played on the roulette gaming machine 1 according to the present embodiment, Keno which is executed as the bonus game on the roulette gaming machine 1 according to the present embodiment will be described. If a bet-with-keno operation is performed, as stated above, messages such as “BET WITH KENO IS INDICATED! YOU WILL HAVE KENO. 1BET IS COLLECTED.” are displayed on the message area 85 of the bet screen 70, as shown in FIG. 8. Then, the one bet is automatically indicated for Keno, which is separate from the amount of the bets by the bet-with-keno operation.

After that, by touching any of the bet squares of the ticket 88C on the chip display area 88 of the bet screen 70, the player selects at most 15 numbers out of the numbers that are displayed on the ticket 88C. With regard to this, as shown in FIG. 9, the number of the selected numbers is displayed on a “Spots” portion of the ticket 88C, and the number which is selected by the player is distinctly displayed using different colors on the bet squares of the ticket 88C. As for the numbers that are marked on the pockets 71B into which the ball 71C is fallen on the wheel 71A in 15 times of Roulette repeated, it may be occasionally expressed “the lucky numbers of Roulette” for simplicity of description. A number corresponded with one of “the lucky numbers of Roulette” is deleted from the square of the ticket 88C, as shown FIG. 1. The number of that “the lucky numbers of Roulette” accords with the player's select numbers is displayed on a “Hits” portion of the ticket 88C.

Then, at a point in time when the 15th Roulette was executed after the player selected the numbers in KENO, the player is awarded the number of credits according to a combination of two numbers that are respectively displayed on the “Spots” portion and the “Hits” portion of the ticket 88C. Here, if the “Hits” portion of the ticket 88C displays “0”, in other words, if the all numbers that are selected by the player are out of accord with “the lucky numbers of Roulette”, the one bet indicated for Keno is converted into the number of credits. The number of converted credits is pooled. The total number of pooled credits is displayed on the amount of pool display area 74 of the bet screen 70 (see FIG. 8) and is awarded to the player who first acquires a payout by a series of Keno executed later.

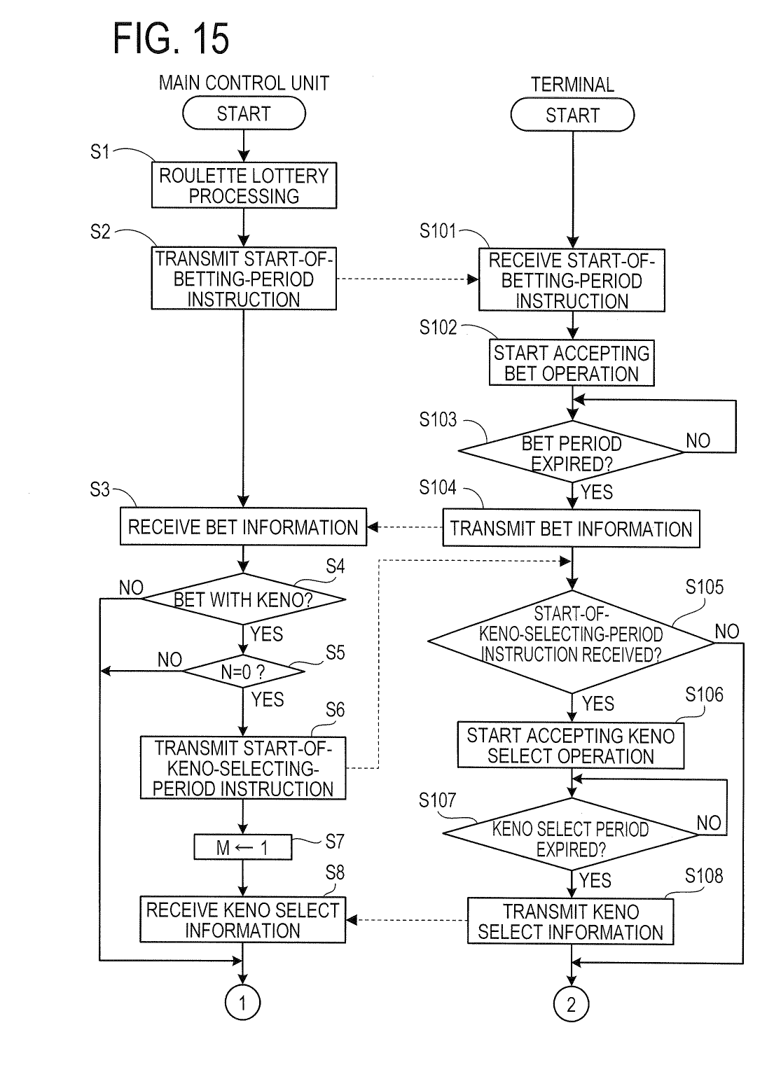

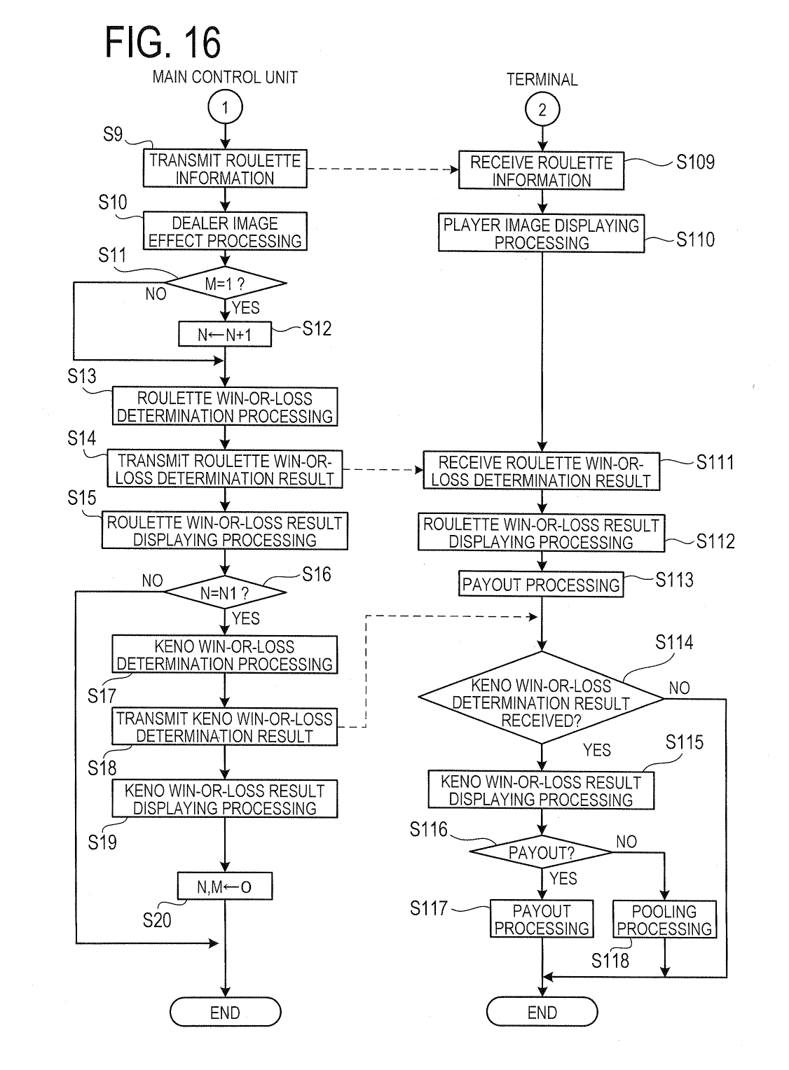

Next, a game processing program executed by the CPU 41 of the main control unit 31 and a game processing program at the terminal side executed by the CPU 51 of the terminal 4, respectively in the roulette gaming machine 1 according to the present embodiment, will be described, referring to FIGS. 15 and 16. Here, respective programs shown as a flow chart in FIGS. 15 and 16 are stored in the RAM 42 or the ROM 43 provided in the main control unit 31, or the RAM 52 or the ROM 53 provided in the terminal 4, and are executed by the CPU 41 or the CPU 51.

First, the game processing program executed by the main control unit 31 will be described, referring to FIGS. 15 and 16. In step (abbreviated to S hereafter) 1, the CPU 41 executes a roulette lottery processing to draw a number that are marked on the pocket 71B into which the ball 71C will be fallen on the wheel 71A. Specifically, a number within the range of 0 to 36 is associated with each one of numbers that were marked on the pockets 71B of the wheel 71A to be used in the Roulette. Then, one of number within the range of 0 to 36 is drawn. A number that is marked the pocket 71B into which the ball 71C will be fallen on the wheel 71A is determined by the drawn number.

Subsequently, in S2, the CPU 41 transmits, to each of the terminals 4, an instruction to start a betting period for accepting the player's bet operation.

Next, in S3, the CPU 41 receives bet information transmitted from each of the terminals 4. Here, the bet information includes information relating to the amount of bets (number of credits) placed by the player and the player's bet target, or information relating to the type of bet (whether or not the bet operation has been performed using the bet-with-keno button 201) placed by the player. In addition, the received bet information of each terminal 4 is temporarily stored in the RAM 42.

Subsequently, in S4, the CPU 41 determines whether or not a bet-with-keno operation has been performed, based on the bet information received from each terminal 4. Here, in this determination, it is determined that a bet-with-a-bonus operation has been performed when a bet has been placed using the bet-with-a-bonus button 201. Then, if it is determined that no bet-with-keno operation has been performed (S4: NO), the process flow proceeds to S9 of FIG. 16 described below. On the other hand, if it is determined that a bet-with-keno operation has been performed (S4: YES), the process flow proceeds to S5. In S5, the CPU 41 determines whether or not the variable N is “0”. Then, if it is determined that the variable N is not “0” (S5: NO), because Keno is executing, the process flow proceeds to S9 of FIG. 16 described below, without executing a processing relating to a selection in Keno. On the other hand, if it is determined that the variable N is “0” (S5: YES), the process flow proceeds to S6. Here, a plurality of the variable N are provided in the RAM 42 and are used for each of the terminals 4 respectively.

In S6, the CPU 41 transmits, to the terminals 4 which a bet-with-keno operation has been performed, an instruction to start a keno selecting period for accepting the player's select operation in Keno. Next, in S7, the CPU 41 substitutes “1” for the variable M. Here, a plurality of the variable M are provided in the RAM 42 and are used for each of the terminals 4 respectively. Therefore, here, the variable M are used for only the terminals 4 which were transmitted the instruction to start a keno selecting period in S6. In S8, the CPU 41 receives keno select information transmitted from the terminals 4. Here, the keno select information includes information relating to numbers selected by the player. In addition, the keno select information received from each of the terminals 4 is temporarily stored in the RAM 42. The process flow proceeds to S9 of FIG. 16.

In S9 of FIG. 16, the CPU 41 transmits, to each of the terminals 4, roulette information (for example, information about the number that was marked on the pocket 71B into which the ball 71C will be fallen on the wheel 71A such as “1”, and the color that was colored to the pocket 71B into which the ball 71C will be fallen on the wheel 71A such as “Red”), based on the lottery result of the roulette lottery processing of S1. Then, in S10, the image 103 of the pocket 71B into which the thrown ball 71C will be fallen on the wheel 71A is displayed on the front display 21 as the main screen 101 (see FIG. 14). Here, the number that is marked on the pocket 71B into which the thrown ball 71C will be fallen on the wheel 71A, based on the lottery result of the roulette lottery processing of S1, are displayed.

Next, in S11, the CPU 41 determines whether or not the variable M is “0”. Then, if it is determined that the variable M is not “0” (S11: NO), because Keno is not executing, the process flow proceeds to S13 described below, without doing anything. On the other hand, if it is determined that the variable M is “0” (S11: YES) , the process flow proceeds to S12. In S12, the CPU 41 increments the value of the variable N. Then, in S13, the CPU 41 compares a number that is marked to the pocket 71B into which the ball 71C will be fallen on the wheel 71A or the color that is colored to the pocket 71B into which the ball 71C will be fallen on the wheel 71A with the player's bet target and determines the win or loss. Since types of the numbers that are marked on the pockets 71B and types of the colors that are colored to the pockets 71B are well known, their explanation is omitted here.

Subsequently, in S14, the determination result of roulette win or loss in S13 is transmitted to each of the terminals 4. Additionally, in S15, the CPU 41 displays, on the main screen 101 of the front display 21, an announcement image announcing the determination result of roulette win or loss of each terminal 4.

Next, in S16, the CPU 41 determines whether or not the variable M is a predefined number N1. The predefined number N1 (in the present embodiment, “15”) is the maximum number the player can select in Keno. Then, for the terminal 4 which it is determined that the variable M is not the predefined number N1 (S16: NO), the game processing program terminates without doing anything. On the other hand, for the terminal 4 which it is determined that the variable M is a predefined number N1 (S16: YES), the process flow proceeds to S17. In S17, the CPU 41 executes a keno win or loss determination processing to terminate executing of KINO.

In S17 of the keno win or loss determination processing, the CPU 41 calculates the player's select numbers accords with the numbers of that “the lucky numbers of Roulette” in Roulette of the past 15 times. The CPU 41 determines the number of credits as the bonus payout, based on the numbers calculated and the numbers of the numbers the player selected in KINO. Then, “the lucky numbers of Roulette” in Roulette of the past 15 times, the numbers calculated, and the number of credits as the bonus payout is included to a determination result of keno win or loss by the CPU 41. Here, the number of credits as the bonus payout is determined based on a table stored previously in ROM 43. If the number of credits as the bonus payout is not “0”, credits converted from the one bet indicated for Keno in the terminal 4 is pooled in the pot. The number of pooled credits is included to the determination result of keno win or loss by the CPU 41.

Then, in S18, the CPU 41 transmits the determination result of keno win or loss to the terminal 4. In S19, the CPU 41 displays, on the main screen 101 of the front display 21, an announcement image announcing the determination result of keno win or loss of the terminal 4. Then, the CPU 41 initializes the variables N, M to “0” and terminates the game processing program.

Next, the game processing program executed by the terminal 4 will be described, referring to FIGS. 15 and 16. In S101, the CPU 51 receives the instruction to start the betting period from the main control unit 31.

Subsequently, in S102, the CPU 51 displays the bet screen 70 (see FIGS. 1, 8, 11 and 13) on the liquid crystal display 10, and identifies the player's bet target and the amount of bets (the number of credits) which has been placed, based on operation information from the touch panel 11. In addition, the CPU 51 identifies the type of bet placed by the player (whether or not a bet operation has been performed using the bet-with-keno button 201). Furthermore, the CPU 51 displays the images 72 of chips on the bet screen 70.

Next, in S103, the CPU 51 determines whether or not the betting period has expired. Specifically, it is determined whether or not a predefined time length (e.g. 20 sec) has passed since accepting the bet operation was started in S102.

If it is determined that the betting period has not expired (S103: NO), accepting the bet operation is continued. If, on the other hand, it is determined that the betting period has expired (S103: YES), the process flow proceeds to S104.

In S104, the CPU 51 transmits the bet information to the main control unit 31. Here, the bet information includes the information relating to the amount of bets (the number of credits) placed by the player and the player's bet target, or the information relating to the type of bet (whether or not the bet operation has been performed using the bet-with-keno button 201) placed by the player.

Then, in S105, the CPU 51 determines whether or not the instruction to start a keno selecting period is received from the main control unit 31. If it is determines the instruction to start a keno selecting period is not received from the main control unit 31 (S105: NO), the process flow proceeds to S108 of FIG. 16 described below, without doing anything. On the other hand, it is determines the instruction to start a keno selecting period is received from the main control unit 31 (S105: YES), the process flow proceeds to S106.

In S106, the CPU 51 identifies numbers that is selected in Keno, based on operation information which is output from the touch panel 11. With regard to this, the CPU 51 distinctly displays the selected numbers using different colors in the bet squares of the ticket 88C on the chip display area 88 (see FIG. 9). Furthermore, the CPU 51 counts the number of the selected numbers. The counted number, as a total number of the selection, is displayed on the “Spots” portion of the ticket 88C by the CPU 51 (see FIG. 9). Here, the player can cancel a selection of number by touching again a place where the selection of number is displayed on the touch panel 11. The CPU 51 displays the canceled numbers using original color in the bet squares of the ticket 88C on the chip display area 88. The player can select a number to “15” at the maximum. If the counted number exceeded “15”, the CPU 51 does not accept a selection of number after the counted number exceeded “15”.

Next, the CPU 51 determines whether or not a keno selecting period has expired. Specifically, it is determined whether or not a predefined time length (e.g. 20 sec) has passed since accepting the select operation in Keno was started in S106.

If it is determined that the keno selecting period has not expired (S107: NO), accepting the select operation in Keno is continued. If, on the other hand, it is determined that the keno selecting period has expired (S107: YES), the process flow proceeds to S108.

In S108, the CPU 51 transmits keno select information to the main control unit 31. The keno select information includes information relation to the total number of the selected numbers and each of the numbers selected by the player.

Then, in S109 of FIG. 16, the CPU 51 receives the roulette information (information such as the pocket 71B into which the ball 71C will be fallen on the wheel 71A) from the main control unit 31. Then, in S110, the CPU 51 displays, on the bet screen 70, the pocket 71B into which the ball 71C is fallen on the wheel 71A, based on the roulette information received in S109. Here, the wheel 71A displayed in S110 are displayed as a series of images (see FIG. 7). In the series of images, the wheel 71A is spinning, the ball 71C is thrown, the ball 71C is falling into one of the pockets 71B, and the wheel 71A is stopping.

Subsequently, in S111, the CPU 51 receives the determination result of win or loss transmitted from the main control unit 31. Then, in S112, the CPU 51 displays, on the liquid crystal display 10, the determination result of win or loss of the player who is playing at the terminal 4, based on the determination result of win or loss received in S111. Specifically, a character string “YOU WON!” is displayed on the win-or-loss display area 95 of the bet screen 70 (see FIG. 13) when the player wins for the bet. Furthermore, a character string “YOU LOST!” is displayed when the player loses for the bet.

Subsequently, in S113, an ordinary payout is made by the CPU 51. Specifically, credits multiplied the odds of the player's bet target by the amount of bets (number of credits) which has been placed are paid to the player if the player wins for the bet.

Next, in S114, the CPU 41 determines whether or not the determination result of keno win or loss was received from the main control unit 31. If it is determined that the determination result of keno win or loss was not received from the main control unit 31 (S114: NO), the game processing program terminates. On the other hand, if it is determined that the determination result of keno win or loss was received from the main control unit 31 (S114: YES), the process flow proceeds to S115 to terminate executing of Keno.

In S115, the CPU 41 displays the determination result of keno win or loss received from the main control unit 31. Specifically, as shown in FIG. 10, in the bet squares of the ticket 88C on the chip display area 88, the CPU 41 deletes “the lucky numbers of Roulette” of the past 15 times. Furthermore, the CPU 41 displays, on a “Hits” portion of the ticket 88C of the chip display area 88, the number of that “the lucky numbers of Roulette” accords with the player's select numbers.

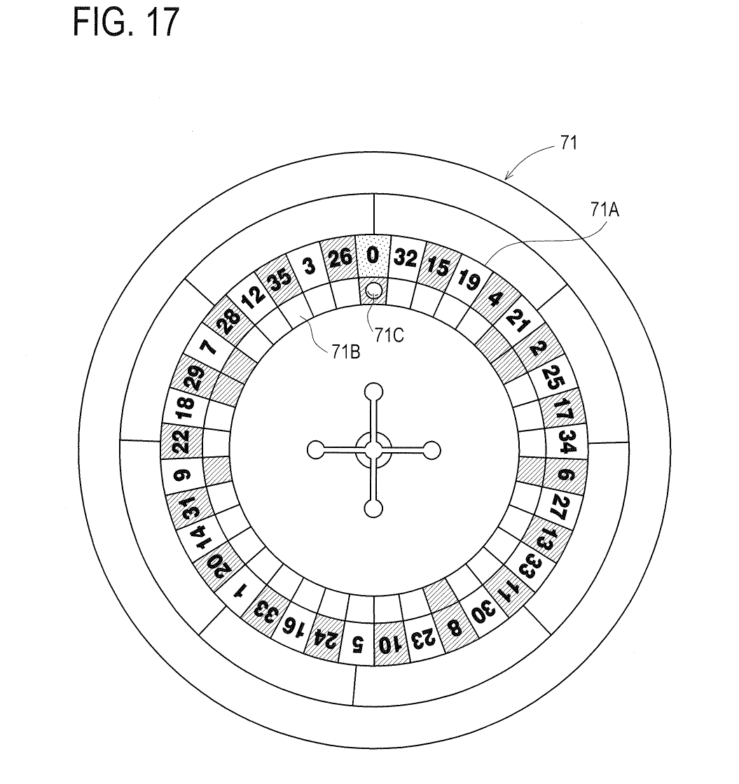

Here, as shown in FIG. 17, about numbers same as “the lucky numbers of Roulette” of the past 15 times, the pockets 71B (of the part into which the ball 71C is fallen) which the same numbers are marked is distinctly displayed using different colors on the wheel 71A of the wheel display area 71.

Additionally, these display processing may be executed whenever “the lucky numbers of Roulette” of one time is determined.

Then, in S106, the CPU 41 determines whether or not there is the bonus payout, based on the determination result of keno win or loss received from the main control unit 31. If it is determined that there is the bonus payout (S116: YES), the CPU 41 executes a payout processing of S117. In S117, the CPU 41 adds the credits as the bonus payout included in the determination result of keno win or loss received from the main control unit 31 to the number of credits held by the player at the terminal 4 and stores the sum in RAM 52. On the other hand, if it is determined that there is not the bonus payout (S116: NO), the CPU 41 executes a pooling processing of S118. In S118, the CPU 41 displays, on the amount of pool display area 74 of the bet screen 70, the number of pooled credits included in the determination result of keno win or loss received from the main control unit 31. Then, the game processing program terminates.

Note that the present invention is not limited to the above examples, and various kinds of improvement or modification are possible without deviating from the scope of the present invention.

For example, in the present embodiment, at a point in time when the 15th Roulette is terminated, from the selection of number by the player in Keno, the player is awarded, as the bonus payout, the number of credits according to a combination of two numbers that are respectively displayed on the “Spots” portion and the “Hits” portion of the ticket 88C of the chip display area 88 on the bet screen 70 (S117, see FIG. 10). With regard to this, the bonus payout may be changed randomly or be fixed uniformly. If a number more than “1” is displayed on the “Hits” portion, regardless of a number displayed on the “Spots” portion, the player may be awarded the bonus payout. If “15” (the maximum selected number) accords with both a number that are displayed on the “Spots” portion and a number that are displayed on the “Hits” portion, the player may be awarded the bonus payout.

The selection of number in Keno may be randomly determined by one of the main control unit 31 and the terminal 4, in stead of indicating by the player.

Additionally, with the present embodiment, the roulette gaming machine 1 which executes Roulette and the bonus game (Keno) may be a gaming machine on which the above-mentioned control unit 31 and the terminal 4 are integrated.

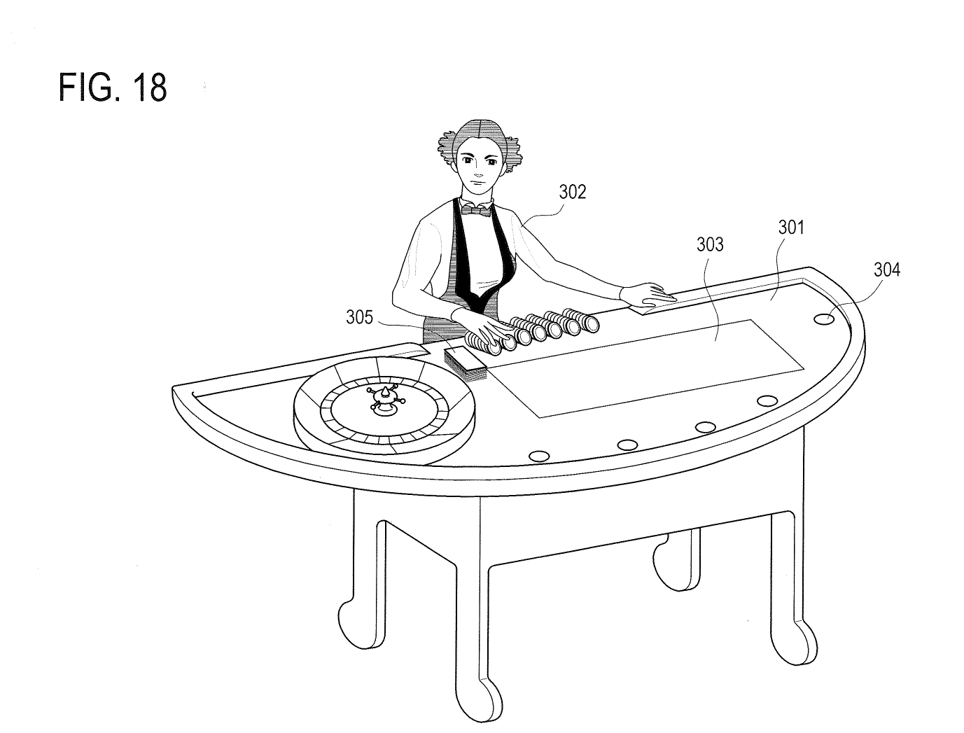

In addition, the playing method of Roulette according to the present invention can also be applied to Roulette (so-called table game) played by the dealer 302 and the player (not shown) on a gaming table 301, as shown in FIG. 18.

In the table game shown in FIG. 18, the dealer 302 prepares a wheel, a ball and so like when playing Roulette and, on the gaming table 301, throws the ball onto the spun wheel. The player places a bet by putting chips on a betting board 303 of the gaming table 301. In this occasion, if chips are further put on a particular spot 304 adjacent to the betting board 303, the dealer 302 determines that a bet-with-keno operation has been performed. However, the dealer 302 may also determine that a bet-with-keno operation has been performed if special chips are put on the betting board 303.

In addition, the dealer 302 distributes one piece of ticket 305 for the player who performed the bet-with-keno operation when playing the bonus game (Keno). The player selects at most 15 numbers out of numbers that are printed on the ticket 88C in the bonus game (Keno). However, the dealer 302 may distribute one of shuffled tickets 305 on which the selected numbers are printed previously. In this manner, the player can select a number to 15 at the maximum in the bonus game (Keno).

Here, with regard to Roulette, the actual game playing method is similar to that of the roulette gaming machine 1 except that the dealer 302 performs throwing the ball onto the spun wheel directly.

What is claimed is:

1. A gaming machine comprising:
a display device for displaying a ball, a wheel including a plurality of pockets where a number is marked respectively and the ball is fallen, and a ticket marking each of the numbers marked on the pockets;
an operation unit for allowing a player to indicate the number of bets of one of a first type and a second type for a plurality of bet spots;
a memory for storing the number of credits held by the player; and
a processor for executing roulette by using the ball and the wheel which are displayed on the display device when the number of bets of the first type is indicated by an operation on the operation unit,
the processor, when the number of bets of the second type is indicated by an operation on the operation unit, programmed to execute the roulette and processes of:
(a) selecting a predefined number of numbers out of the numbers which marked on the ticket displayed on the display device;
(b) determining whether or not one of the selected numbers accords with the number which is marked on the pocket into where the ball is fallen by executing of the roulette after the selection and after displaying, on the display device, a state of that the ball is fallen into the pocket by executing of the roulette; and
(c) adding the number of credits according to the total numbers of the determined numbers of the accordance, at a point in time when the determination repeated a predefined number of times, as a side bet bonus, to the number of credits in the memory and storing the sum.

2. The gaming machine according to claim 1, further comprising:
an input unit for allowing the player to enter instructions; and wherein
the processor is programmed to do the selection, based on the player's enter instructions by an operation on the input unit.

3. The gaming machine according to claim 1, wherein
the processor is programmed to randomly do the selection.

4. The gaming machine according to claim 1, wherein
the processor is programmed to randomly change the credits as the side bet bonus.

5. The gaming machine according to claim 1, wherein
the processor is programmed to execute processes of:
(a) making the predefined number of times of the determination equal to the predefined number of numbers of the selection; and
(b) adding the number of credits, as the side bet bonus, to the number of credits in the memory and storing the sum, if, in the determination, all of the selected numbers are determined as the accordance.

6. The gaming machine according to claim 1, wherein
the processor is programmed to execute processes of:
(a) making the predefined number of times of the determination equal to the predefined number of numbers of the selection; and
(b) adding the number of credits, as the side bet bonus, to the number of credits in the memory and storing the sum, if, in the determination, any of the selected numbers are determined as the accordance.

7. The gaming machine according to claim 1, wherein
the processor is programmed to execute processes of:
(a) pooling the number of credits as the side bet bonus if the number of credits as the side bet bonus is not added to the number of credits in the memory and not stored the sum; and
(b) displaying the pooled number of credits on the display device and contributing the pooled number of credits for the side bet bonus.

8. A game playing method which executes a roulette by using a ball and a wheel including a plurality of pockets where a number is marked respectively and the ball is fallen when a player indicates the number of bets of a first type, comprising, so as to make a game proceed with the roulette, the steps of: when the player indicates the number of bets of a second type,
(a) selecting a predefined number of numbers out of the numbers marked on a ticket marking each of the numbers marked on the pockets;
(b) determining whether or not one of the selected numbers accords with the number which is marked on the pocket into where the ball is fallen by executing of the roulette after the selection and after the ball's falling into the pocket by executing of the roulette; and
(c) awarding, to the player, as a side bet bonus, the number of credits according to the total numbers of the determined numbers of the accordance at a point in time when the determination repeated a predefined number of times.

9. The game playing method according to claim 8 comprising the steps of:
doing the selection, based on the player's instructions.

10. The game playing method according to claim 8 comprising the steps of:
randomly doing the selection.

11. The game playing method according to claim 8 comprising the steps of:
randomly changing the credits as the side bet bonus.

12. The game playing method according to claim 8 comprising, so as to make the game proceed, the steps of:
(a) making the predefined number of times of the determination equal to the predefined number of numbers of the selection; and
(b) awarding the number of credits as the side bet bonus to the player, if, in the determination, all of the selected numbers are determined as the accordance.

13. The game playing method according to claim 8 comprising, so as to make the game proceed, the steps of:
(a) making the predefined number of times of the determination equal to the predefined number of numbers of the selection; and
(b) awarding the number of credits as the side bet bonus to the player, if, in the determination, any of the selected numbers are determined as the accordance.

14. The game playing method according to claim 8 comprising, so as to make the game proceed, the steps of:
(a) pooling the number of credits as the side bet bonus if the player is not awarded the number of credits as the side bet bonus; and
(b) contributing the pooled number of credits for the side bet bonus.
